(19) United States
(12) Patent Application Publication
(10) Pub. No.: US 2023/0279995 A1
(43) Pub. Date: Sep. 7, 2023

(54) HYDROGEN REFUELING STATION AND SYSTEM, AND METHOD OF USING THE SAME

(71) Applicants: China Energy Investment Corporation Limited, Beijing (CN); National Institute of Clean-and-Low-Carbon Energy, Beijing (CN)

(72) Inventors: Xianming Li, Orefield, PA (US); Anthony Ku, Fremont, CA (US); Edward Youn, Pacific Grove, CA (US); Ashwin Ramteke, San Jose, CA (US)

(73) Assignees: China Energy Investment Corporation Limited, Beijing (CN); National Institute of Clean-and-Low-Carbon Energy, Beijing (CN)

(21) Appl. No.: 17/686,069

(22) Filed: Mar. 3, 2022

(51) Int. Cl. F17C 5/00; F17C 7/04

(52) U.S. Cl. CPC F17C 5/007; F17C 7/04; F17C 2205/0352; F17C 2221/012; F17C 2223/0161; F17C 2223/036; F17C 2227/0135; F17C 2227/03; F17C 2265/065; F17C 2270/0139; F17C 2270/0184

(57) ABSTRACT

A system and a method for dispensing a liquefied fuel (e.g., hydrogen) are provided. The system includes a cryotank for storing a liquefied fuel, a first liquid pump and a second liquid pump. The first pump has a first maximum flow rate and pumps a first stream of the liquefied fuel having a first pressure. The second pump has a second and lower maximum flow rate, and pumps a second stream of the liquefied fuel has a second and higher pressure. Each pump is connected with a heat exchanger to vaporize a stream of the liquefied fuel to provide a respective vaporized substream. Each pump is also connected with a mixer, which combines the respective vaporized substream and a respective second substream of the liquefied fuel to provide a respective gaseous fuel stream. The gaseous fuel streams can be separately or jointly dispensed to one or more vehicles through a piping manifold and at least one dispenser.

### PRIORITY CLAIM AND CROSS-REFERENCE

None.

### FIELD OF THE INVENTION

The disclosure relates to a system and a method for refueling a liquefied fuel generally. More particularly, the disclosed subject matter relates to a refueling station, a system, and a method for refueling hydrogen to vehicles.

### BACKGROUND

Most motor vehicles are currently powered by internal combustion engines with fossil fuels. Due to limited supply and adverse environmental effects associated with burning petroleum-derived fuels, vehicles are now being developed that are powered by alternative environmentally friendly fuels like hydrogen. Fuel cells can be used to produce electric power for motor vehicles by electrochemically reacting hydrogen fuel with an oxidant such as air. Hydrogen refueling stations for fuel cell vehicles can store fuel as a liquid before it is dispensed to vehicles as compressed gaseous hydrogen. Fueling or refueling hydrogen to fuel cell vehicles (FCV) and other hydrogen-powered vehicles presents different challenges from adding petroleum-based fuels like gasoline into a vehicle.

### SUMMARY OF THE INVENTION

The present disclosure provides a refueling station, a system, and a method for dispensing a liquefied fuel and refueling vehicles. For example, the liquefied fuel comprises or is hydrogen, and the system is a refueling station or a system for dispensing hydrogen. The system is for refueling hydrogen to fuel-cell based vehicles in some embodiments.

In accordance with some embodiments, such a system comprises a cryotank configured to store a liquefied fuel therein, a first pump, and a second pump. The first pump has a first maximum flow rate and is configured to compress and provide a first stream of the liquefied fuel having a first pressure from the cryotank. The second pump has a second maximum flow rate and is configured to provide a second stream of the liquefied fuel having a second pressure from the cryotank. The second maximum flow rate is lower than the first maximum flow rate, and the second pressure is higher than the first pressure.

The system further comprises a first heat exchanger, a first mixer, a second heat exchanger, and a second mixer. The first heat exchanger is fluidly connected with the first pump and is configured to vaporize a first substream from the first stream of the liquefied fuel to provide the first vaporized substream. The first mixer is fluidly connected with the first pump and the first heat exchanger, and is configured to combine the first vaporized substream and a second substream from the first stream of the liquefied fuel to provide a first gaseous fuel stream. The second heat exchanger is fluidly connected with the second pump and is configured to vaporize a third substream, which is from the second stream of the liquefied fuel, to provide the second vaporized substream. The second mixer is fluidly connected with the second pump and the second heat exchanger, and is configured to combine the second vaporized substream and a fourth substream, which is from the second stream of the liquefied fuel, to provide a second gaseous fuel stream.

The system further comprises a piping manifold and at least one dispenser. The piping manifold is fluidly connected with the two mixers, and is configured to deliver either or both of the first gaseous fuel stream and the second gaseous fuel stream to the at least one dispenser, which is configured to dispense either or both of the first gaseous fuel stream and the second gaseous fuel stream into an on-board storage tank in a vehicle or respective tanks in multiple vehicles.

In some embodiments, the liquefied fuel is liquid hydrogen, and the system is a hydrogen refueling station or system. Each of the first pump and the second pump is configured to be disposed inside the cryotank. The pumps are submerged liquid pumps.

In some embodiments, the first gaseous fuel stream is a compressed gaseous stream having a pressure between 25 MPa and 50 MPa and a temperature between -50° C. and an ambient temperature such as 20° C. The second gaseous fuel stream is a compressed gaseous stream having a pressure between 50 MPa and 90 MPa and a temperature between -50° C. and an ambient temperature such as 20° C. For example, in some embodiments, the first gaseous fuel stream and the second gaseous fuel stream have a pressure to meet a filling capability of 35 MPa and 70 MPa, respectively. The first maximum flow rate of the first pump is up to 280 Kg/hr. The second maximum flow rate of the second pump is less than 200 Kg/hr.

In some embodiments, there are at least two dispensers configured to refueling at least two vehicles simultaneously.

In some embodiments, the system further comprises one or more additional pumps. The system comprises three or more pumps in total with different combinations of pressure and flow capability. The system may comprise multiple sets of a two-pump combination including the first pump, the second pump, the first heat exchanger, the second heat exchange, the first mixer and the second mixer as described herein.

In some embodiments, the system further comprises an additional cryotank, which is configured to hold at least one pump therein.

In accordance with some embodiments, the present disclosure provides a hydrogen refueling station, which comprises a cryotank configured to store hydrogen as a liquefied fuel therein, a first pump, and a second pump. The first pump has a first maximum flow rate and is configured to compress and provide a first stream of the liquefied fuel having a first pressure from the cryotank. The second pump has a second maximum flow rate and is configured to compress and provide a second stream of the liquefied fuel having a second pressure from the cryotank. The second maximum flow rate is lower than the first maximum flow rate, and the second pressure is higher than the first pressure.

The hydrogen refueling station further comprises a heat exchanger and a mixer corresponding to each pump as described herein. A first heat exchanger is fluidly connected with the first pump and is configured to vaporize a first substream from the first stream of the liquefied fuel to provide the first vaporized substream. A first mixer is fluidly connected with the first pump and the first heat exchanger, and is configured to combine the first vaporized substream and a second substream from the first stream of the liquefied fuel to provide a first gaseous fuel stream. A second heat exchanger is fluidly connected with the second pump and configured to vaporize a third substream from the second stream of the liquefied fuel to provide the second vaporized substream. A second mixer is fluidly connected with the second pump and the second heat exchanger, and is configured to combine the second vaporized substream and a fourth substream from the second stream of the liquefied fuel to provide a second gaseous fuel stream.

The system further comprises a piping manifold fluidly connected with the first mixer and the second mixer, and at least one dispenser fluidly connected with the piping manifold. The piping manifold is configured to deliver either or both of the first gaseous fuel stream and the second gaseous fuel stream to the at least one dispenser, which dispenses such a gaseous fuel stream or streams into a vehicle or vehicles.

In some embodiments, the first gaseous fuel stream and the second gaseous fuel stream have a pressure to meet a filling capability of 35 MPa and 70 MPa, respectively. The first and second pumps can meet the filling capability of 35 MPa and 70 MPa, respectively. There are at least two dispensers configured to refueling at least two vehicles simultaneously.

In some embodiments, the system and the hydrogen refueling station further comprise a controller, which is configured to adjust a ratio of the first gaseous fuel stream and the second gaseous fuel stream to be dispensed to the at least one dispenser.

In another aspect, a method or methods of using the system or the station are provided. For example, in accordance with some embodiments, such as method comprises steps of providing a liquefied fuel such as hydrogen stored inside a cryotank, connecting one of the at least one dispenser to an on-board storage tank of a fuel cell vehicle, initiating a refueling process by dispensing the first gaseous fuel stream with lower pressure into the on-board storage tank, and completing the refueling process by dispensing at least one portion of the second gaseous fuel stream with higher pressure into the on-board storage tank. During the refueling process, a mixture of the first gaseous fuel stream and the second gaseous fuel stream may be also dispensed.

In some embodiments, the at least one dispenser comprises a first dispenser and a second dispenser. Such a method comprises providing a liquefied fuel such as hydrogen stored inside a cryotank, and providing at least two vehicles in sequence. An arrival time between the at least two vehicles is less than a time needed to refueling any of the at least two vehicles. The method further comprises connecting a first dispenser to an on-board storage tank of a first vehicle, refueling the first vehicle, connecting a second dispenser to an on-board storage tank of a second vehicle, and refueling the second vehicle.

The process of refueling the first vehicle may include initiating refueling the first vehicle by dispensing the first gaseous fuel stream into the on-board storage tank of the first vehicle, and completing refueling the first vehicle by dispensing at least one portion of the second gaseous fuel stream into the on-board storage tank of the first vehicle. For refueling the second vehicle, in the initiation stage, the second gaseous fuel stream may be dispensed into the on-board storage tank of the second vehicle when the first gaseous fuel stream is dispensed into the on-board storage tank of the first vehicle, or vice versa. The first gaseous fuel stream may be dispensed into the second vehicle when the second gaseous fuel stream is dispensed to the first vehicle. During the completion stage of refueling the second vehicle, at least one portion of the second gaseous fuel stream (i.e. stream with higher pressure) can be dispensed into the on-board storage tank of the second vehicle. This is done when refueling the first vehicle is completed to avoid that the second stream having higher pressure is needed for both vehicles.

The pumps have the capabilities as descried herein. For example, the first gaseous fuel stream and the second gaseous fuel stream have a pressure to meet a filling capability of 35 MPa and 70 MPa, respectively.

The system and the method provided in the present disclosure provide many advantages as described herein. For example, in some embodiments, the present disclosure provides a system for refueling hydrogen to multiple fuel cell vehicles simultaneously, through multiple dispensers and multiple fluid circuits. The fluid circuit can provide various pressure capabilities. The fill rate and vehicle throughput of a refueling station can be significantly improved.

### BRIEF DESCRIPTION OF THE DRAWINGS

The present disclosure is best understood from the following detailed description when read in conjunction with the accompanying drawings. It is emphasized that, according to common practice, the various features of the drawings are not necessarily to scale. On the contrary, the dimensions of the various features are arbitrarily expanded or reduced for clarity. Like reference numerals denote like features throughout specification and drawings.

FIG. 1 is a schematic block diagram illustrating an exemplary system comprising a plurality of pumps and a plurality of fluid circuits in accordance with some embodiments.

FIG. 2 is a schematic block diagram illustrating an exemplary portion of exemplary system of FIG. 1 using two pumps having a capability of 30 MPa and 70 MPa, respectively, in accordance with some embodiments.

FIG. 3 is a schematic block diagram illustrating a comparative example with two independent pumps each having a capability of 70 MPa.

FIGS. 4-5 illustrate an exemplary calculation for determining a required fill time needed to deliver 90 kg hydrogen into a 70 MPa fill using a single pump in the comparative example of FIG. 3, with a discharge pressure of 96 MPa, a maximum flow of 5 kg/min max, and a peak power of 200 kW.

FIG. 4 shows a tank pressure (P), a tank temperature (T), and an instantaneous power (in kW) as a function of time. FIG. 5 shows a tank pressure, an instantaneous flow rate (mdot, in kg/min), and state of charge (SOC) as a function of time.

FIGS. 6-7 illustrate an exemplary calculation for determining a required fill time needed to deliver 90 kg hydrogen into a 70 MPa fill using two pumps in the exemplary system of FIG. 1, with a discharge pressure of 45 MPa and 96 MPa, respectively, a maximum flow of 5 kg/min max, and a peak power of 200 kW.

FIG. 6 shows a tank pressure (P), a tank temperature (T), and an instantaneous power (in kW) as a function of time. FIG. 7 shows a tank pressure, an instantaneous flow rate (mdot, in kg/min), and state of charge (SOC) as a function of time.

FIG. 8 illustrates probability distribution function (pdf) for arrival time intervals for a sample calculation involving 60 vehicles.

FIG. 9 illustrates probability distribution function (pdf) for departure time intervals for the sample calculation involving 60 vehicles.

FIG. 10 is a schematic block diagram illustrating a configuration of an exemplary system comprising two pumps and a plurality of fluid circuits in accordance with some embodiments.

FIG. 11 is an exemplary state machine diagram for the exemplary system of FIG. 10 in accordance with some embodiments.

FIG. 12 is an exemplary state machine diagram for a low pressure pump (e.g., H35 having 35 MPa capability) in the exemplary system of FIG. 10 in accordance with some embodiments.

FIG. 13 is an exemplary state machine diagram for a high pressure pump (e.g., H70 having 70 MPa capability) in the exemplary system of FIG. 10 in accordance with some embodiments.

FIG. 14 is a flow chart illustrating an exemplary method in accordance with some embodiments.

FIGS. 15-16 are flow charts illustrating an exemplary method for refueling at least two vehicles in accordance with some embodiments.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

For purposes of the description hereinafter, it is to be understood that the embodiments described below may assume alternative variations and embodiments. It is also to be understood that the specific articles, compositions, and/or processes described herein are exemplary and should not be considered as limiting.

In the present disclosure the singular forms “a,” “an,” and “the” include the plural reference, and reference to a particular numerical value includes at least that particular value, unless the context clearly indicates otherwise. When values are expressed as approximations, by use of the antecedent “about,” it will be understood that the particular value forms another embodiment. As used herein, “about X” (where X is a numerical value) preferably refers to ±10% of the recited value, inclusive. For example, the phrase “about 8” preferably refers to a value of 7.2 to 8.8, inclusive. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” It is intended that any component, element, attribute, or step that is positively recited herein may be explicitly excluded in the claims, whether such components, elements, attributes, or steps are listed as alternatives or whether they are recited in isolation.

Unless it is expressly stated otherwise, the term “substantially” such as in “substantially the same” used herein will be understood to encompass a parameter with a fluctuation in a suitable range, for example, with ±10% or ±15% fluctuation of the parameter. In some embodiments, the range of fluctuation is within ±10%.

Unless expressly indicated otherwise, a liquefied fuel such as hydrogen is stored in a storage tank, and pumped out using a pump in liquid form. It can be dispensed as a gaseous fuel or liquid fuel into a receiving tank in a vehicle. In the present disclosure, the terms “fueling” and “refueling” are used interchangeably.

As used herein, when an element or component is described as forming a “connected to,” “coupled to,” “coupled with” or “in contact with” another element or component, it can be directly connected to, directly coupled with, in direct contact with, or intervening elements or components may be connected, coupled or in contact with the particular element or component. When an element or component is referred to as being “directly connected to,” “directly coupled to,” “directly coupled with,” or “directly in contact with” another element, there are no intervening elements or components.

As used herein, the terms “thermally coupled to” or “thermally coupled with” used herein will be understood that the components are coupled together directly or through an intervening component so that heat can be transferred among the components, and the components may be in direct contacted with each other or the intervening component contact the components. As used herein, the terms “fluidly coupled (or connected) to” or “fluidly coupled (or connected) with” used herein will be understood that the components are connected with pipes or lines and configured to have gas or liquid flow through the components. As used herein, the terms “electronically connected” or “electrically connected” used herein will be understood to encompass electrical connection using wires or wireless connection.

The term “fluid circuit” used herein will be understood as a pathway for liquefied fuel in liquid or gas phase from a cryotank and a pump to a dispenser, particularly the fuel pathway between a pump and a pipe manifold.

A check valve as described herein is a one-way valve, which opens automatically in one direction only or is closed. A switching valve as described herein is controllable to be closed or to be open to flow a fluid in one direction only. A block valve as described herein is controllable to be closed or open so as to block or permit a fluid to move in one or more direction.

The term “ambient temperature” used herein will be understood as a temperature under ambient condition, for example, a room temperature of 20-22° C.

The present disclosure provides a refueling station, a system, and a method for dispensing a liquefied fuel and refueling vehicles. For example, the liquefied fuel comprises or is hydrogen, and the system is a refueling station or a system for dispensing hydrogen. The system is for refueling hydrogen to fuel-cell based vehicles in some embodiments. In the system or hydrogen refueling station, at least two liquid H₂ cryopumps with different pressure and flow rate capabilities are used to deliver compressed gaseous H₂ to vehicular storage tanks.

The present disclosure also provides a method for refueling one or more hydrogen fuel cell vehicles. An onboard storage tank of an vehicle is filled with compressed gaseous H₂ from at least two different pump circuits (or called fluid circuits).

In existing hydrogen refueling station, a single dispenser is supported by a single fluid circuit, which is connected to a hydrogen storage reservoir. In the system or station provided in the present disclosure, a plurality of dispensers can be fluidly connected to a plurality of fluid circuits. A single fluid circuit can be connected to one or more dispensers, and a single dispenser can also be connected to and supported by multiple fluid circuits, which are connected to a same hydrogen reservoir. Multiple fluid circuits can be used to deliver hydrogen through a single dispenser to a vehicle during a fill. A plurality of fuel cell vehicles can be refueled in series (sequentially) or in parallel (at the same time) at a refueling station.

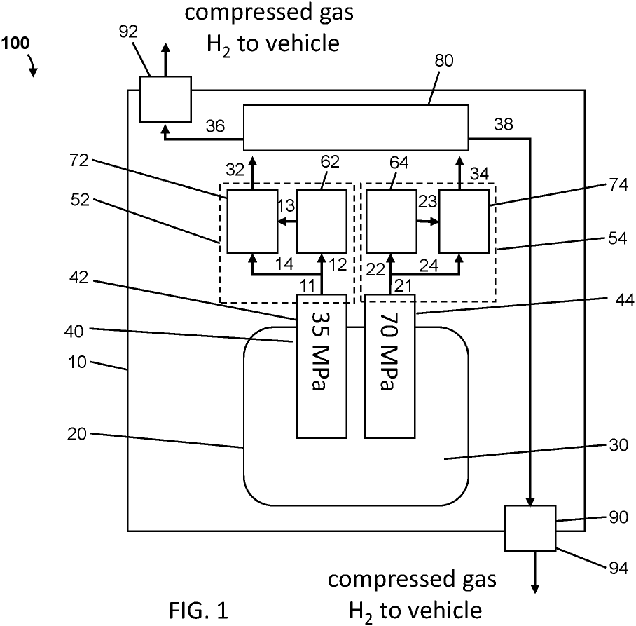

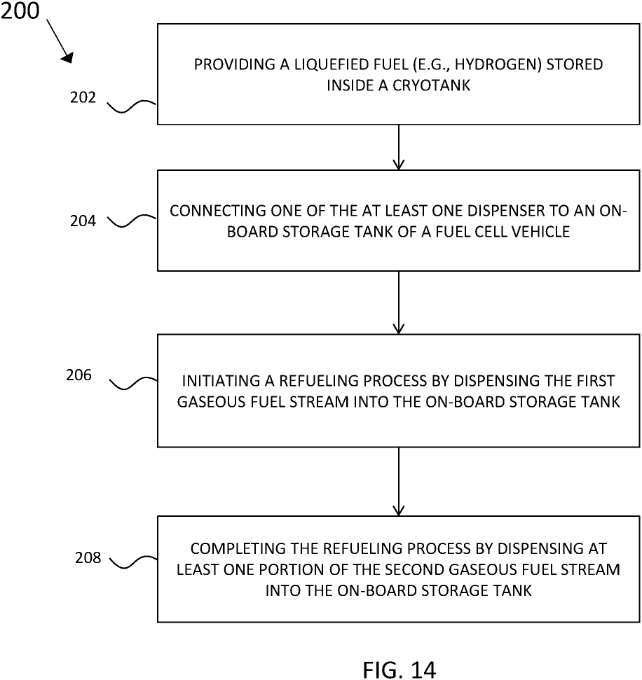

In FIGS. 1, 2, and 10, like items are indicated by like reference numerals, and for brevity, descriptions of the structure, provided above with reference to the preceding figures, are not repeated. The method described in FIG. 14 is described with reference to the exemplary structures described in FIGS. 1, 2, and 10.

Refer to FIG. 1, an exemplary system 100 in accordance with some embodiments is illustrated. An enclosure 10 is a service island. The system 100 comprises a cryotank 20 and at least two pump 40, which includes a first pump 42 and a second pump 44.

The cryotank 20 may be a double-wall cryotank with an external wall and internal wall. The space between the two walls is in vacuum or filled with insulation materials. The cryotank 20 is configured to store a liquefied fuel 30 such as liquid hydrogen therein. The cryotank 20 may be an insulated tank suitable for storing a liquefied fuel 30 such as liquid hydrogen at low temperature and under pressure. In some embodiments, the liquefied fuel 30 comprises or is hydrogen. A vapor phase (boil-off) of the liquefied fuel 30 may exist above the liquid phase of the liquefied fuel 30 in a headspace inside the cryotank 20. The cryotank 20 may have a suitable capacity, for example, 400 kg (1500 gal), 1200 kg (4500 gal), or 4800 kg (18 k gal).

The pump 40 is configured to be disposed inside the cryotank 20 and provide a stream of the liquefied fuel from the cryotank 20. The pump 40 is a submergible pump having a pump intake port submerged inside the liquefied fuel 30 in the cryotank 20 during use. The pump 40 is inserted into the cryotank 20, and can be taken out for maintenance.

The first pump 42 has a first maximum flow rate and is configured to compress and provide a first stream 11 of the liquefied fuel 30 having a first pressure from the cryotank 20. The second pump 44 has a second maximum flow rate and is configured to provide a second stream 21 of the liquefied fuel 30 having a second pressure from the cryotank 20. The second maximum flow rate is lower than the first maximum flow rate, and the second pressure is higher than the first pressure.

The system 100 further comprises a first heat exchanger 62, a first mixer 72, a second heat exchanger 64, and a second mixer 74. The first heat exchanger 62 is fluidly connected with the first pump 42 and is configured to vaporize a first substream 12 from the first stream 11 of the liquefied fuel 30 to provide the first vaporized substream 13. The first mixer 72 is fluidly connected with the first pump 42 and the first heat exchanger 62, and is configured to combine the first vaporized substream 13 and a second substream 14 from the first stream 11 of the liquefied fuel 30 to provide a first gaseous fuel stream 32. The second heat exchanger 64 is fluidly connected with the second pump 44 and is configured to vaporize a third substream 22, which is from the second stream 21 of the liquefied fuel 30, to provide the second vaporized substream 23. The second mixer 34 is fluidly connected with the second pump 44 and the second heat exchanger 64, and is configured to combine the second vaporized substream 23 and a fourth substream 24, which is from the second stream of the liquefied fuel, to provide a second gaseous fuel stream 34.

The system 100 further comprises a piping manifold 80 and at least one dispenser 90. For example, the at least one dispenser includes a first dispenser 92 and a second dispenser 94 as shown in FIG. 1. The piping manifold 80 is fluidly connected with the two mixers 72 and 74, and is configured to deliver either or both of the first gaseous fuel stream 32 and the second gaseous fuel stream 34 to the at least one dispenser 90. The dispenser 90 such as dispenser 92 or 94 is configured to dispense a compressed gaseous fuel stream 36 or 38 from either or both of the first gaseous fuel stream 32 and the second gaseous fuel stream 34 into an on-board storage tank (not shown) in a vehicle or respective tanks in multiple vehicles. In some embodiments, at least one dispenser 90 comprises at least two dispensers configured to refueling at least two vehicles simultaneously.

In FIG. 1, two blocks in dashed lines represent fluid circuits 52 and 54 associated with each pump, respectively. Each fluid circuit may include a pump, a respective heat exchanger and a respective mixer. Sometimes a fluid circuit may also include the piping manifold 80 and a dispenser 90.

The piping manifold 80 is capable of switching gas flow from the first fluid circuit 52 to the second fluid circuit 54 without disconnecting the dispenser hose from the vehicle. The piping manifold 80 is also capable of directing flow from either fluid circuit to a first dispenser 92, and the flow from a different fluid circuit to a different dispenser. The piping manifold 80 is also capable of combining flow from both fluid circuits and directing the flow to a single dispenser.

In some embodiments, the first gaseous fuel stream 32 is a compressed gaseous stream having a pressure between 25 MPa and 50 MPa and a temperature between -50° C. and an ambient temperature such as 20° C. For example, the first gaseous fuel stream 32 may have a pressure in the range from 35 MPa to 45 MPa or from 35 MPa to 40 MPa. The second gaseous fuel stream 34 is a compressed gaseous stream having a pressure between 50 MPa and 90 MPa and a temperature between -50° C. and an ambient temperature such as 20° C. For example, in some embodiments, the first gaseous fuel stream and the second gaseous fuel stream have a pressure to meet a filling capability of 35 MPa and 70 MPa, respectively. The pressure values of 35 MPa and 70 MPa as labeled on the first pump 42 and the second pump 44, respectively, in FIG. 1, are for illustration only. These values represented exemplary capabilities of the two pumps. Corresponding to these two pressure valves, the first maximum flow rate of the first pump 42 is up to 280 Kg/hr, and the second maximum flow rate of the second pump 44 is less than 200 Kg/hr in some embodiments.

In some embodiments, the system 100 further comprises one or more additional pumps 40. The system 100 comprises three or more pumps 40 in total with different combinations of pressure and flow capabilities. For example, four dispensers may be fed by four pumps. The system may also comprise multiple sets of a two-pump combination including the first pump 42, the second pump 44, the first heat exchanger 62, the second heat exchanger 64, the first mixer 72, and the second mixer 74 as described above.

In some embodiments, the system 100 further comprises an additional cryotank 20, which is configured to hold at least one pump 40 therein. For example, the system 100 may include two cryotanks 20. One cryotank is for two 35 MPa pumps and the other cryotank houses one or more 70 MPa pumps.

A dispenser 90 may have an average fill rate higher than 5 Kg/min or higher than 4 Kg/min. The final pressure in the vehicle tank may be greater than 66.5 MPa, corresponding to a SOC of 95%.

In accordance with some embodiments, the present disclosure provides a hydrogen refueling station as an example of the exemplary system 100. The station includes a cryotank 20, a first pump 42, and a second pump 44 as described above. Compared to the first pump 42, the second pump 44 has a lower maximum flow rate and can compress and provide a second stream 21 of the liquefied fuel 30 having a higher pressure from the cryotank 20.

The hydrogen refueling station further comprises a heat exchanger and a mixer corresponding to each pump, including a first heat exchanger 62, a first mixer 72, a second heat exchanger 64, and a second mixer 74 in a first fluid circuit 52 and a second fluid circuit 54, as described above. The first mixer 72 is configured to provide a first gaseous fuel stream 32. The second mixer is configured to provide a second gaseous fuel stream 34.

The station further comprises a piping manifold 80 fluidly connected with the first mixer 72 and the second mixer 74, and at least one dispenser 90 fluidly connected with the piping manifold 80. The piping manifold 80 is configured to deliver either or both of the first gaseous fuel stream 32 and the second gaseous fuel stream 35 to the at least one dispenser, which dispenses such a gaseous fuel stream or streams 36 and 38 into a vehicle or vehicles. Multiple liquid pumps with different pressure and flow capabilities can be used. The piping manifold 80 allows the fuel to be delivered using different pump circuits, in series or parallel, without disconnecting the dispenser from the vehicle.

In some embodiments, the first gaseous fuel stream 32 and the second gaseous fuel stream 34 have a pressure to meet a filling capability of 35 MPa and 70 MPa, respectively. The first and second pumps 42 and 44 can meet the filling capability of 35 MPa and 70 MPa, respectively. The at least one dispenser 90 comprises at least two dispensers 92 and 94 configured to refueling at least two vehicles simultaneously.

In some embodiments, the system 100 such as a hydrogen refueling station further comprises a controller (not shown), which is configured to adjust a ratio of the first gaseous fuel stream and the second gaseous fuel stream to be dispensed to the at least one dispenser.

The system 100 has several advantages. For example, the system comprises at least two pumps and fluid circuits, in which a first pump has higher flow and lower outlet pressure and a second pump has lower flow but higher outlet pressure. The at least two pumps and two fluid circuits are used to deliver high flow, high pressure vehicle fills. The system provides a station configuration, in which at least two dispensers are connected to two pump-enabled fluid circuits. Such a system is used to deliver high-throughput vehicle refueling at high pressure.

The performance benefit is also in fill time for multiple vehicles at a station. This design offers higher vehicle throughput than stations using the same total number of pumps, but only a single high pressure, low flow pump to deliver each vehicle fill. The use of more than one fluid circuit is used to deliver the fills, during a multi-vehicle sequence.

As a comparison, when a single fluid circuit is used, the single fluid circuit or a single type of circuit would limit the fill rate to the flow rates for the high pressure pumps. To achieve the desired flow rate, more pumps are required. Otherwise, there will be incomplete fills using a lower pressure pump.

In the system 100, a low-pressure pump-enabled fluid circuit can be used first to deliver a portion of the total fill quickly, followed by the use of a high pressure pump-enabled fluid circuit to complete the fill without disconnecting the vehicle from the dispenser.

The two-pump system can complete a 70 MPa fill in less time than a single 70 MPa-capable fluid circuit. The two-pump system can complete two 70 MPa fills using two dispensers in the same time or faster than a system with two 70 MPa-capable pumps independently connected to two dispensers. In other words, the system 100 offers advantages in filling time when using the same number of pumps. For example, the 2-pump hybrid system as described herein can offer faster average filling times relative to a configuration with two independent 70 MPa-capable pump circuits. In situations where the interval between vehicle arrivals at the station is longer than the time needed for a single 70 MPa-capable pump circuit to complete the fill, the only advantage of the system disclosed herein is reduced operation time. However, when the interval between vehicle arrivals becomes shorter than the time needed for a single 70 MPa-capable pump circuit to complete the fill, a two-pump system can complete the fills at a faster average rate, increase station throughput, reduce operation time, and labor cost.

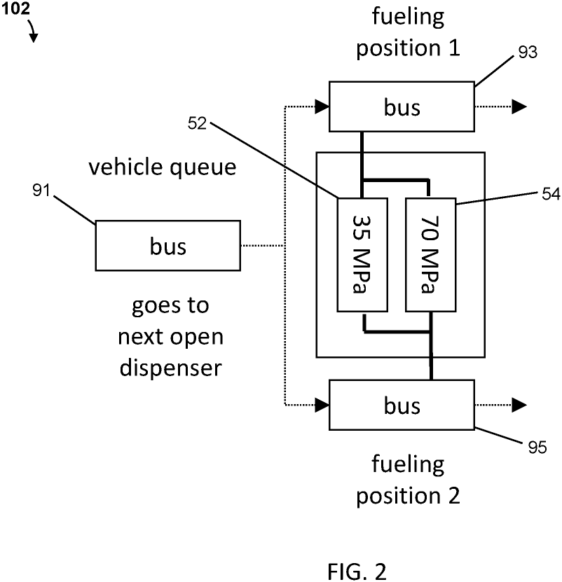

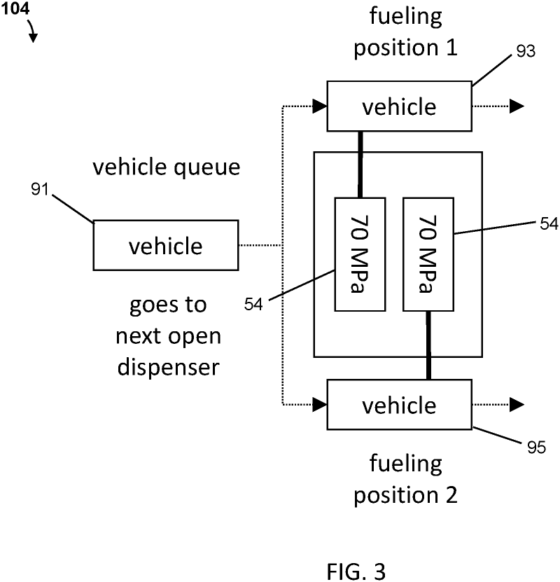

FIG. 2 illustrates a portion of exemplary system 100 using two pumps having a capability of 30 MPa and 70 MPa, respectively, in accordance with some embodiments. FIG. 3 illustrates a comparative example with two independent pumps each having a capability of 70 MPa.

Referring to FIG. 2, an exemplary design of a service island 102 for refueling fuel cell vehicles such as buses 91, 93, and 95 is illustrated. Such a design includes two fluid circuits 52 and 54 having two pumps 42 and 44 and other components as described in FIG. 1, with capability of 35 MPa and 70 MPa, respectively. This service island is shown with two refueling positions (as shown on the top and in the bottom of FIG. 1), each serviced by a dispenser. The dotted lines with arrows show moving directions of the vehicles. The bus 91 in a queue will advance to the next available open refueling position.

As a comparison, in the comparative example 104 as shown in FIG. 3, only one type of fluid circuit 54 having pump 44 are used. Two pumps, each of which has a capability of 70 MPa, are used. The two fluid circuits 54 of the same type are not connected. Each fluid circuit separately provides gaseous hydrogen to a respective dispenser.

The system 100 having the exemplary design of a service island 102 utilizes a 35 MPa-capable pump (50 MPa pump discharge) circuit 52 and a 70 MPa-capable (96 MPa pump discharge) pump circuit 54. In accordance with some embodiments, each refueling fill begins with a portion from the 35 MPa-capable pump circuit 52, followed by a portion from the 70 MPa-capable pump circuit 54. Subsequent vehicles are filled by these circuits in this order, as they arrive and the appropriate circuit becomes available after completing its portion of its current fill. In this embodiment, a high flow 35 MPa-capable pump circuit that delivers a first portion of the fill and a 70 MPa-capable pump circuit that delivers a second portion of the fill, without disconnecting the dispenser hose from the vehicle.

Such a system also utilizes at least two dispensers to fuel at least two vehicles in parallel, starting with a stream from one pump, followed by a stream from a second pump without switching dispenser hoses. The piping manifold 80 is used to switch flow from either of the two pump circuits 52, 54 to either of two vehicles undergoing refueling. In a two-vehicle, two-dispenser system, a first vehicle receives a first portion of a fill from a 35 MPa-capable pump circuit, followed by a second portion of a fill from a 70 MPa-capable pump circuit. The second vehicle is connected to a second dispenser, and starts receiving a first portion of a fill from the 35 MPa-capable pump circuit, after it has completed delivering a first portion of a fill to the first vehicle. The second vehicle would receive a first portion of a fill from the 35 MPa-capable pump circuit in parallel to the delivery of the second portion of a fill from the 70 MPa-capable pump circuit to the first vehicle. The second vehicle then receives a second portion of a fill from the 70 MPa-capable pump circuit when the first portion of its fill is complete and the 70 MPa-capable pump circuit has completed the second portion of a fill to the first vehicle.

A variation is considered when a second vehicle arrives and the 70 MPa-capable pump circuit is idle because the first vehicle is still receiving its first portion of the fill from the 35 MPa-capable pump circuit. In this situation, the 70 MPa-capable pump circuit begins the fill, as soon as the 35 MPa-capable pump circuit has completed its first portion fill of the first vehicle. The manifold switches the flows from the pump circuits so that the 70 MPa-capable pump circuit delivers the second portion of the the fill to the first vehicle, and the 35 MPa-capable pump circuit completes the first portion of the fill to the second vehicle. Once the 70 MPa-capable pump circuit has completed the second portion to the first vehicle, the manifold switches the flow to deliver the second portion of the fill to the second vehicle after the 35 MPa-capable pump circuit has completed the first portion of the fill in the second vehicle. The filling sequence will be replicated with subsequent vehicles, allowing rapid back-to-back refueling of multiple vehicles. In these embodiments as shown in FIG. 2, only a single pump circuit is used to provide fuel to any single dispenser at any given time.

For the system 100 having the exemplary design of a service island 102 as shown in FIG. 2, time needed for a fill were calculated for filling hydrogen fuel of 90 kg at 70 MPa. The first pump 42 is a higher flow, low pressure pump capable of 240 kg/hr at 45 MPa discharge with 35 MPa at a dispenser. The second pump 44 is a lower flow, high pressure pump capable of 120 kg/hr at 96 MPa discharge with 70 MPa at a dispenser. The calculations were done using data from Refprop thermodynamic database, and SAE J2601, Fueling Protocols For Light Duty Gaseous Hydrogen Surface Vehicles.

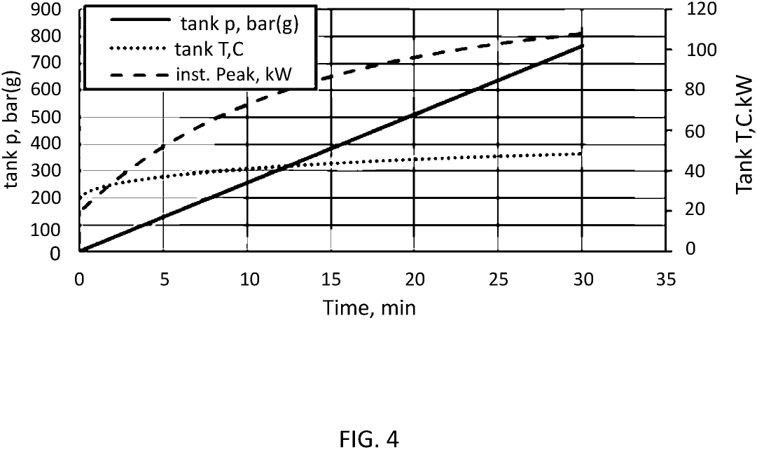

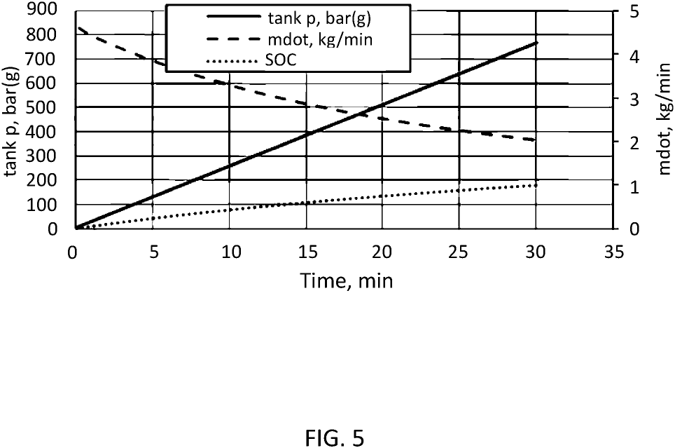

FIGS. 4-5 illustrate an exemplary calculation for determining a required fill time needed to deliver 90 kg hydrogen into a 70 MPa fill using a single pump in the comparative example of FIG. 3, with a discharge pressure of 96 MPa. FIG. 4 shows a tank pressure (P), a tank temperature (T), and an instantaneous power (in kW) as a function of time. FIG. 5 shows a tank pressure, an instantaneous flow rate (mdot, in kg/min), and state of charge (SOC) as a function of time. Conforming to the SAE J2601 requirement, a maximum flow of 5 kg/min max and a peak power of 200 kW, a fill takes 29.1 minutes.

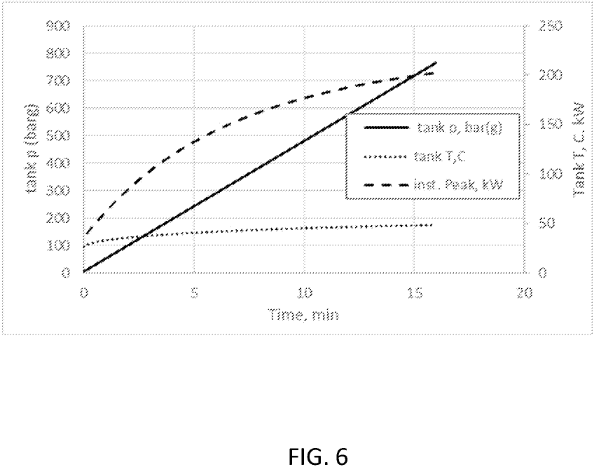

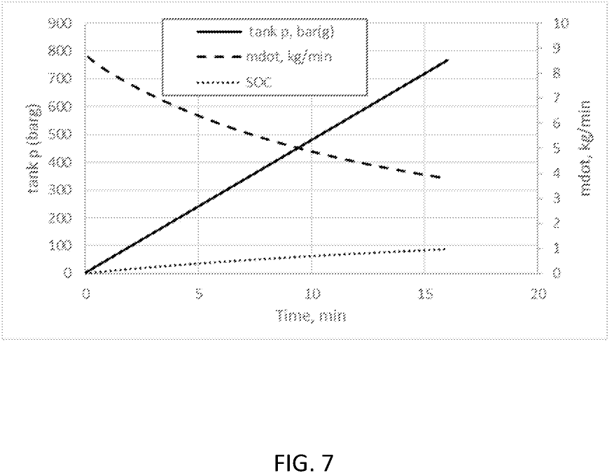

FIGS. 6-7 illustrate an exemplary calculation for determining a required fill time needed to deliver 90 kg hydrogen into a 70 MPa fill using two pumps in the exemplary system of FIG. 1 having the design shown in FIG. 2, with a discharge pressure of 45 MPa and 96 MPa, respectively, a maximum flow of 5 kg/min max, and a peak power of 200 kW. FIG. 6 shows a tank pressure (P), a tank temperature (T), and an instantaneous power (in kW) as a function of time. FIG. 7 shows a tank pressure, an instantaneous flow rate (mdot, in kg/min), and state of charge (SOC) as a function of time.

The configuration uses a 45 MPa pump to deliver 59 kg, followed by a 96 MPa pump to complete the fill. Conforming to the J2601 requirements, and a maximum output of 5 kg/min and peak power of 200 kW, a fill takes a total of 15.5 minutes. The 45 MPa pump is used for 9 minutes, followed by the 96 MPa pump for 6.5 minutes.

In the system 100 having the design of FIGS. 1-2, two scenarios have been considered. In Scenario 1, the arrival times of vehicles such as buses 91 are widely-spaced and the intervals are longer than an average time for a fill needed in one dispenser 90. In Scenario 2, the arrival times of vehicles are closely-spaced and the intervals are shorter than an average time for a fill needed.

In Scenario 1, vehicle arrival times are random, but are spaced on average longer than the time needed to complete a fill using a single pump. The solution utilizes multiple pumps but only one per fill gives the fastest average fill time.

In the limit where the vehicle arrival times are spaced more widely than the time needed to fill a vehicle, the fill time for a head-to-head comparison favors the hybrid solution (15.5 min vs 29.1 min). In an alternate configuration where the same total number of pumps are used the results show the average fill times are nearly comparable. In two independent pump circuits in the comparative example of FIG. 3, the fill time is 14.55 minutes. In the hybrid pump configuration as shown in FIG. 2, the fill time is 15.5 minutes, and the system has an advantage in fill time at the system level, but not on a per-pump basis.

In Scenario 2 with closely-spaced arrivals, when vehicles arrive at random, but faster than the fill times, a queue is formed. In the comparative example, the vehicles will alternate through the two filling positions, with each vehicle remaining at the station for 29.1 minutes and then departing. In the example of this present disclosure, a first vehicle receives a first portion of its fill from the 35 MPa-capable pump circuit for 9 minutes, and then the remainder of the fill from the 70 MPa-capable pump circuit. A second vehicle arriving at the second refueling position receives a first portion of its fill from the 35 MPa-capable pump circuit when it becomes available; the remainder of the fill is delivered from the 70 MPa-capable pump circuit when it becomes available.

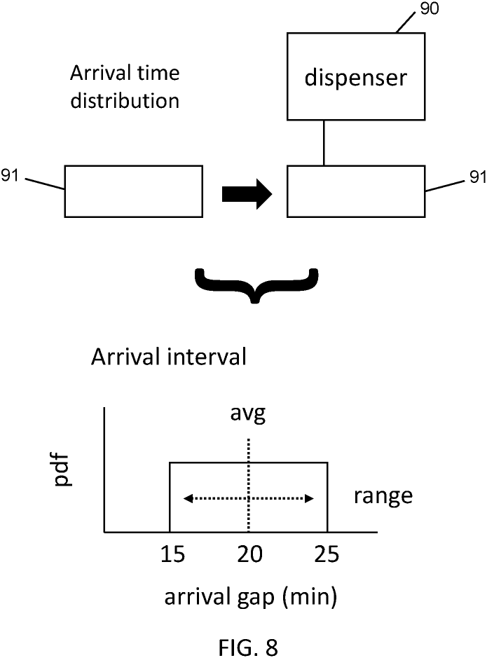

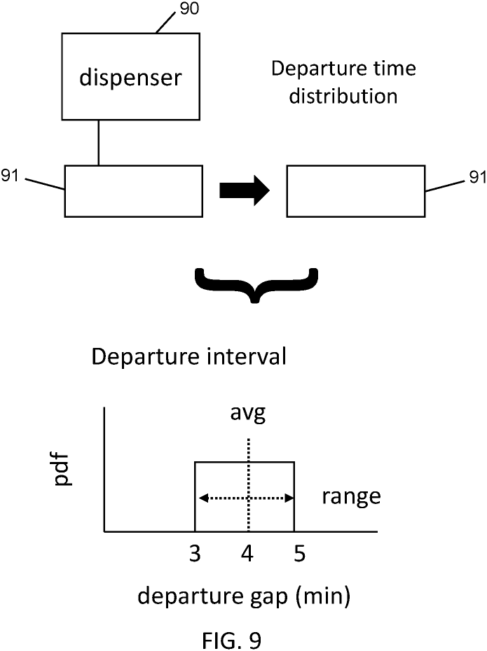

FIGS. 8-9 illustrate examples of arrival and departure time intervals. FIG. 8 illustrates probability distribution function (pdf) for arrival time intervals for a sample calculation involving 60 vehicles. As shown in FIG. 8, the average arrival gap may be approximately 20 minutes, ranging from 15 minutes to 25 minutes.

FIG. 9 illustrates probability distribution function (pdf) for departure time intervals for the sample calculation involving 60 vehicles. The departure gap is 4 minutes on average, ranging from 3 minutes to 5 minutes.

Twenty simulations of 30 vehicles in total were run, with an average arrival time spacing of 5 minutes, 10 minutes, and 20 minutes, respectively. When vehicles arrive randomly at an average of 10 minute apart, the average vehicle throughput is about 31% higher than the comparative example. When vehicles arrive randomly at an average of 20 minute apart, the average vehicle throughput is about 1% higher than the comparative example. When vehicles arrive randomly at an average of 5 minute apart, the average vehicle throughput is about 38% higher than the comparative example.

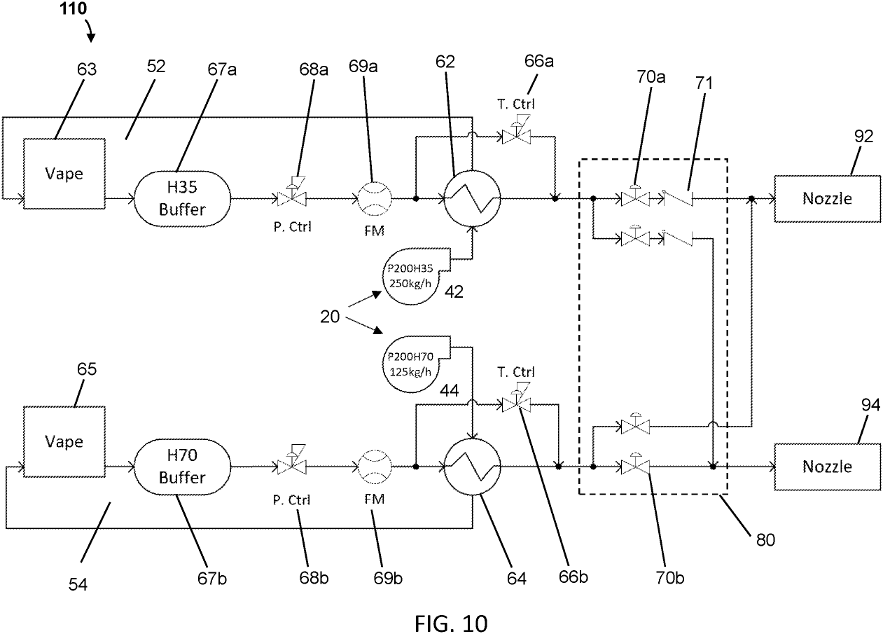

FIG. 10 illustrates another configuration 110 of an exemplary system 100 comprising two pumps and a plurality of fluid circuits in accordance with some embodiments. The pumps in the cryotank 20 are a P200H35 unit as the first pump 42 capable of 45 MPa discharge and 250 kg/h flow, and a P200H70 unit as the second pump 44 capable of 96 MPa discharge and 125 kg/h flow. There are at least two fluid circuits 52 and 54. As shown in FIG. 10, the configuration 110 of FIG. 10 also include heat exchanger 62 and 64, vaporizers (“Vape”) 63 and 65, buffer tanks 67a and 67b, pressure controller valves (“P.Ctrl”) 68a and 68b, flow meters (FM) 69a and 69b, temperature controller valves (T.Ctrl) 66a and 66b, for the 35 MPa-capable pump circuit (H35) and 70 MPa-capable pump circuit (H70), respectively. The piping manifold 80 includes valves 70a and 70b and check valves 71, which are used to select either or both of gaseous hydrogen fuels from the two fluid circuits 52 and 54 and then supplied to one of the two nozzles 92 and 94. For example, for each nozzle, at least three options include the gaseous hydrogen fuel from the first fluid circuit 52 only, from the second fluid circuit 54 only, or a combination from the two circuits 52 and 54. The fuels from both circuits can be optionally combined in different ratios.

The system 100 having the configuration of FIG. 10 and the method of using the same are similar to those as the system 100 having the configuration as shown in FIG. 2. One difference is that the piping manifold 80 allows for the possibility of at least two pump circuits simultaneously providing fuel to a single dispenser 90 such as dispenser 92 or 94. Two guiding principles can be applied for using the higher pressure 70 MPa-capable pump circuit: (1) to maximize the use of the pump, and (2) to contribute to the fill that has the highest tank pressure at the moment the pump circuit becomes available.

There are four scenarios: (1) when a first vehicle arrives, the fill begins with fluid from both the 35 MPa-capable pump circuit and the 70 MPa-capable pump circuit. When the fill reaches an intermediate level (above the maximum pressure of the 35 MPa-capable pump circuit), then the 35 MPa-capable pump circuit stops contributing to the first vehicle fill, and the fill is completed using the 70 MPa-capable pump circuit. (2) When a second vehicle arrives while the first vehicle is receiving a fill, the 35 MPa-capable pump circuit switches over after the first vehicle tank reaches the max pressure capability of the 35 MPa-capable pump circuit. The 70 MPa-capable pump completes the fill for the first vehicle, then switches over to the second vehicle to complete the fill. (3) In the case of two vehicles arriving simultaneously at two dispensers, both pumps work in tandem to deliver a first portion of a fill to the first vehicle while the second vehicle waits. The 35 MPa-capable pump circuit switches to the second vehicle once the first vehicle tank pressure reaches the max pressure capability of the 35 MPa-capable pump. (4) In the case of a second vehicle arriving at a higher pressure in its onboard tank than the first vehicle at the moment the second dispenser is connected to the vehicle, then the 70 MPa-capable pump circuit switches to the second fill while the 35 MPa-capable pump circuit completes the first portion to the first vehicle. If the first portion of the first vehicle reaches the maximum pressure capability of the 35 MPa-capable pump before the second vehicle has reached the same pressure, the 70 MPa-capable pump will switch back to the first vehicle to complete its fill, and then subsequently complete the fill for the second vehicle. The filling sequence would be replicated with subsequent vehicles, allowing rapid back-to-back refueling of multiple vehicles.

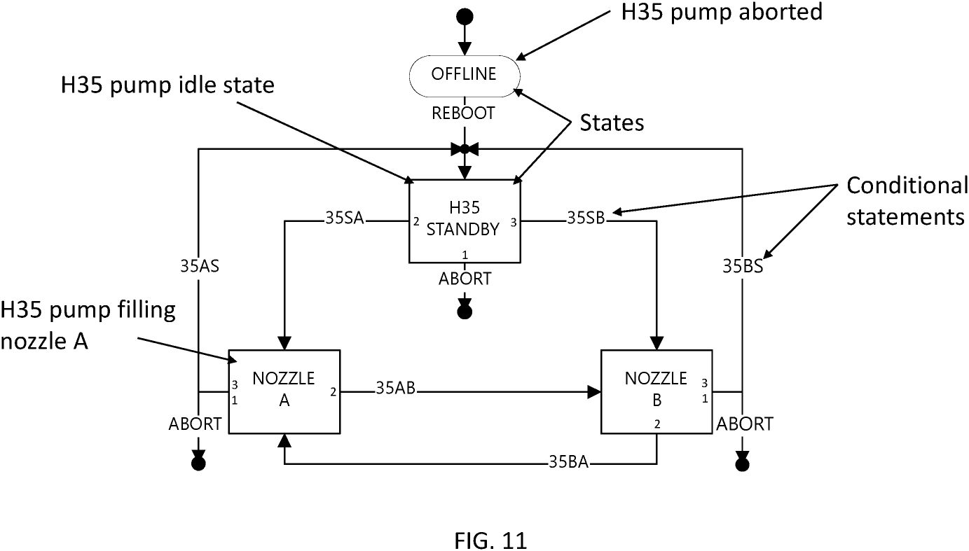

FIG. 11 is an exemplary state machine diagram for the exemplary system of FIG. 10 in accordance with some embodiments. This is an exemplary diagram showing the pump status or state such as H35 pump being idle or aborted, nozzle filling status by a certain pump, and related conditional statements.

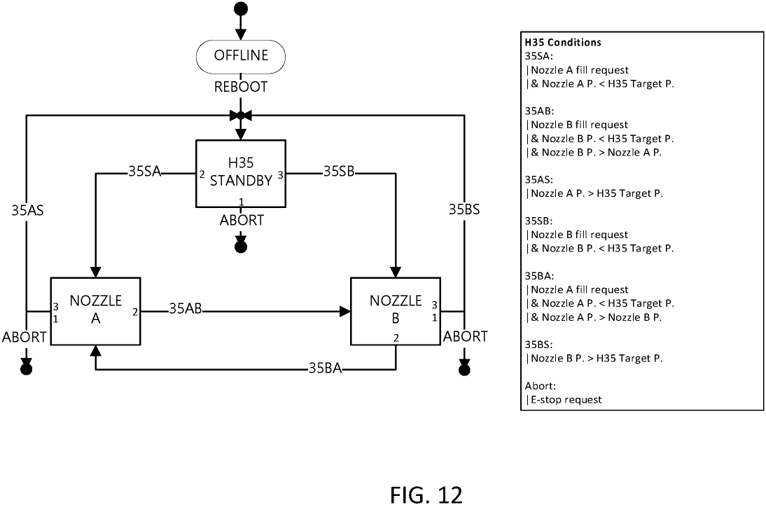

FIG. 12 is an exemplary state machine diagram for a low pressure pump (e.g., H35 having 35 MPa capability) in the exemplary system of FIG. 10 in accordance with some embodiments. The conditional statements of the H35 pump are shown on the right side of FIG. 12. For example, “35SA” means that the first nozzle, Nozzle A, receives a fill request, the pressure of Nozzle A is lower than the target pressure in the H35 pump. Under this condition, the H35 pump fills nozzle A.

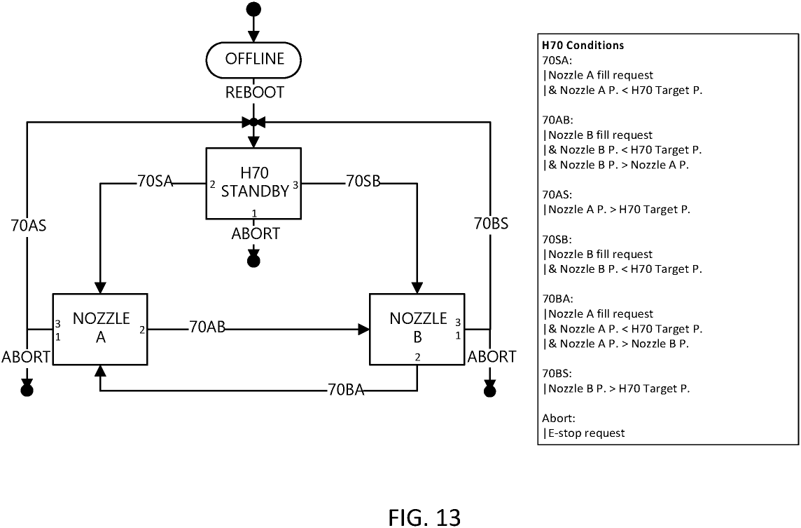

FIG. 13 is an exemplary state machine diagram for a high pressure pump (e.g., H70 having 70 MPa capability) in the exemplary system of FIG. 10 in accordance with some embodiments. The conditional statements of the H70 pump are shown on the right side of FIG. 12. For example, “70SA” means that the first nozzle, Nozzle A, receives a fill request, the pressure of Nozzle A is lower than the target pressure in the H70 pump. Under this condition, the H70 pump fills nozzle A.

In FIGS. 12-13, the H35 pump prioritizes the active nozzle with higher pressure at any given time as long as it is below the H35 limit. The H70 pump prioritizes the active nozzle with higher pressure at any given time as long as it is below the H70 limit.

Simulations were performed by using a 40 kg total tank capacity, average fill rates of 4 Kg/min and 2 Kg/min for the H35 and H70 pumps, respectively, and a maximum pressure capability of 45 MPa for the H35 pump. The objective of simulations was to minimize the H35 idle time, while simultaneously seeking to operation the H70 pump continuously. Both nozzles A and B are H70 nozzles, and the target fill pressure is H70. The H35 pump is used as a fast flow pump a portion of the fill to speed up filling.

In one type of simulations, it was assumed that vehicles arrive with empty tanks. The simulations show that the average vehicle throughput for two H70 pumps operating independently is about 6 vehicles/h in a comparative example system (e.g., the system shown in FIG. 3), while the H35-H70 system 100 can achieve vehicle flow rates between 9 to 10 vehicles/h.

In another type of simulations, it was assumed that vehicles arrive with random initial state of charge ranging from 0 to 35 kg. The simulations show that the average vehicle throughput for two H70 pumps operating independently is about 6 vehicles/h in the comparative example, while the H35-H70 system 100 can achieve vehicle flow rates between 9 to 10 vehicles/h.

From a reliability perspective, if the H70 pump is down, vehicles can be filled to 70% SOC (28 kg of 40 kg total capacity). If the H35 pump is down, fill vehicles full more slowly. For a system with two independent H70 pumps (Comparative Example), the vehicle throughput is about 6 per hour, while the hybrid approach is about 9 or 10 per hour, based on the parameters here.

In another aspect, a method or methods of using the system or the station are provided. Referring to FIG. 14, the present disclosure provides an exemplary method 200 of using the system 100 as described herein.

At step 202, a liquefied fuel 30 is provided and stored inside a cryotank 20. In some embodiments, the liquefied fuel 30 comprises or is hydrogen.

At step 204, one of the at least one dispenser 90 is connected to an on-board storage tank of a fuel cell vehicle.

At step 206, a refueling process is initiated by dispensing the first gaseous fuel stream 32 with lower pressure into the on-board storage tank.

At step 208, at least one portion of the second gaseous fuel stream 34 with higher pressure is dispensed into the on-board storage tank. The refueling process might be close to the completion. During the refueling process, a mixture of the first gaseous fuel stream 32 and the second gaseous fuel stream 34 may be also dispensed. In some embodiments, the liquefied fuel comprises hydrogen, and the method is for refueling hydrogen to a fuel-cell vehicle. The hydrogen fuel can be dispensed to a vehicle at a suitable pressure, for example, 35 MPa or 70 MPa. The compressed hydrogen gas may be at a temperature of -40° C. and be dispensed at a temperature such as -20° C. The gaseous fuel may be at a higher discharge pressure before dispensed. For example, a discharge pressure is 45 MPa and 96 MPa corresponding to a fill pressure of 35 MPa and 70 MPa, respectively.

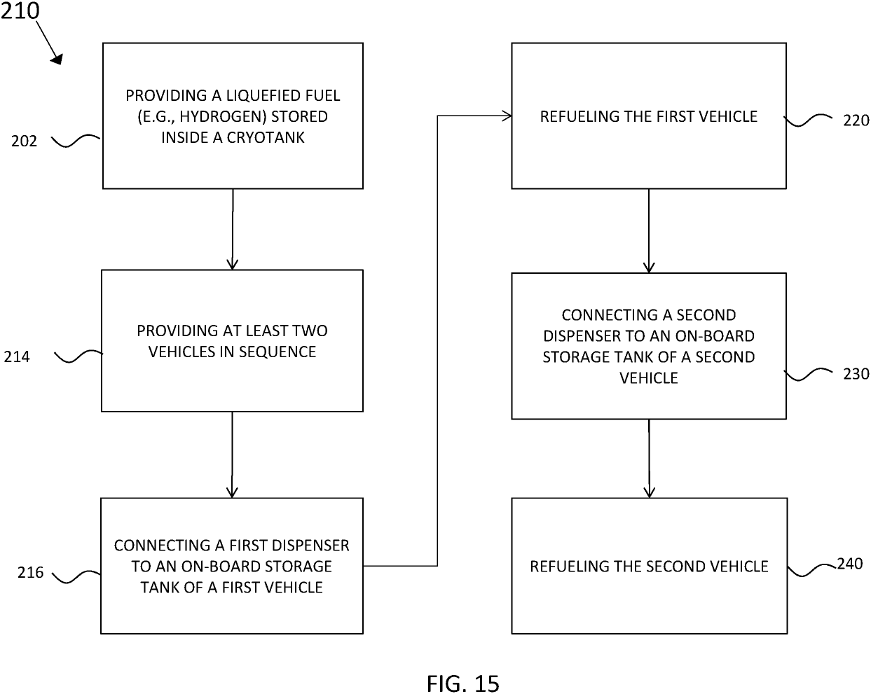

In some embodiments, the at least one dispenser 90 comprises a first dispenser 92 and a second dispenser 94. Referring to FIG. 15, a corresponding exemplary method 210 is provided.

At step 202, a liquefied fuel such as hydrogen stored inside a cryotank is provided.

At step 214, at least two vehicles are provided in sequence. An arrival time between the at least two vehicles is less than a time needed to refueling any of the at least two vehicles. The pumps have the capabilities as descried herein. For example, the first gaseous fuel stream 32 and the second gaseous fuel stream 34 have a pressure to meet a filling capability of 35 MPa and 70 MPa, respectively.

At step 216, a first dispenser 92 is connected to an on-board storage tank of a first vehicle. At step 220, the first vehicle is refueled.

At step 230, a second dispenser 94 is connected to an on-board storage tank of a second vehicle. At step 240, the second vehicle is refueled.

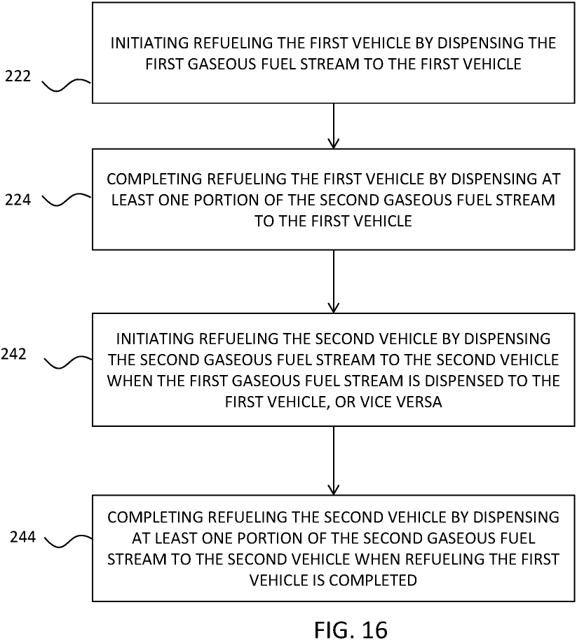

Referring to FIG. 16, step 220 of refueling the first vehicle may include steps 222 and 224, and step 240 of refueling the second vehicle may include steps 242 and 244.

At step 222, in the initiation stage of refueling the first vehicle, the first gaseous fuel stream 32 is dispensed into the on-board storage tank of the first vehicle. At a late and completion stage of refueling the first vehicle, at least one portion of the second gaseous fuel stream 34 having a higher pressure into the on-board storage tank of the first vehicle.

At step 242, in the initiation stage of refueling the second vehicle, the second gaseous fuel stream 34 may be dispensed into the on-board storage tank of the second vehicle when the first gaseous fuel stream 32 is dispensed into the on-board storage tank of the first vehicle. Alternatively, the first gaseous fuel stream 32 may be dispensed into the second vehicle when the second gaseous fuel stream 34 is dispensed to the first vehicle.

At step 244, during the completion stage of refueling the second vehicle, at least one portion of the second gaseous fuel stream 34 (i.e. stream with higher pressure) can be dispensed into the on-board storage tank of the second vehicle. This is done when refueling the first vehicle is completed to avoid that the second stream having higher pressure 34 is needed for both vehicles.

The exemplary system 100 may further comprise a controller for controlling the steps of the method and the components as described herein. The controller may comprise one or more processors and at least one tangible, non-transitory machine readable medium encoded with one or more programs to be executed by the one or more processors to perform the steps in the methods.

In some embodiments, the method to refuel hydrogen fuel cell vehicles using the aforementioned system comprises the connection of a first fuel cell vehicle to a dispenser, and filling the onboard storage tank with compressed gaseous H₂ from at least two different pump circuits, and connecting a second hydrogen fuel cell vehicle to a second dispenser and filling the onboard storage tank with compressed gaseous H₂ from at least two different pump circuits. The fluid flow from the two different pump circuits are routed to a first dispenser, and then a second dispenser. The fluid streams from the at least two different pump circuits can be dispensed in series (sequentially), in parallel (at the same time), or in both modes during the course of the vehicle tank filling process.

The system and the method provided in the present disclosure provide many advantages as described herein. For example, in some embodiments, the present disclosure provides a system for refueling hydrogen to multiple fuel cell vehicles simultaneously, through multiple dispensers and multiple fluid circuits. The fluid circuit can provide various pressure capabilities. The fill rate and vehicle throughput of a refueling station can be significantly improved.

The methods and system described herein may be at least partially embodied in the form of computer-implemented processes and apparatus for practicing those processes. The disclosed methods may also be at least partially embodied in the form of tangible, non-transient machine readable storage media encoded with computer program code. The media may include, for example, RAMs, ROMs, CD-ROMs, DVD-ROMs, BD-ROMs, hard disk drives, flash memories, or any other non-transient machine-readable storage medium, or any combination of these mediums, wherein, when the computer program code is loaded into and executed by a computer, the computer becomes an apparatus for practicing the method. The methods may also be at least partially embodied in the form of a computer into which computer program code is loaded and/or executed, such that, the computer becomes an apparatus for practicing the methods. When implemented on a general-purpose processor, the computer program code segments configure the processor to create specific logic circuits. The methods may alternatively be at least partially embodied in a digital signal processor formed of application specific integrated circuits for performing the methods. The computer or the control unit may be operated remotely using a cloud based system.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a cryotank configured to store a liquefied fuel therein;
a first pump having a first maximum flow rate and configured to provide a first stream of the liquefied fuel having a first pressure from the cryotank;
a second pump having a second maximum flow rate and configured to provide a second stream of the liquefied fuel having a second pressure from the cryotank, wherein the second maximum flow rate is lower than the first maximum flow rate, and the second pressure is higher than the first pressure;
a first heat exchanger fluidly connected with the first pump and configured to vaporize a first substream from the first stream of the liquefied fuel to provide the first vaporized substream;
a first mixer fluidly connected with the first pump and the first heat exchanger, and configured to combine the first vaporized substream and a second substream from the first stream of the liquefied fuel to provide a first gaseous fuel stream;
a second heat exchanger fluidly connected with the second pump and configured to vaporize a third substream from the second stream of the liquefied fuel to provide the second vaporized substream;
a second mixer fluidly connected with the second pump and the second heat exchanger, and configured to combine the second vaporized substream and a fourth substream from the second stream of the liquefied fuel to provide a second gaseous fuel stream;
a piping manifold; and
at least one dispenser,
wherein the piping manifold is configured to deliver either or both of the first gaseous fuel stream and the second gaseous fuel stream to the at least one dispenser, and the at least one dispenser is configured to dispense either or both of the first gaseous fuel stream and the second gaseous fuel stream into an on-board storage tank in a vehicle.

2. The system of claim 1, wherein the liquefied fuel is liquid hydrogen, and the system is a hydrogen refueling system.

3. The system of claim 1, wherein each of the first pump and the second pump is configured to be disposed inside the cryotank.

4. The system of claim 1, wherein the first gaseous fuel stream is a compressed gaseous stream having a pressure between 25 MPa and 50 MPa and a temperature between -50° C. and 20° C.

5. The system of claim 1, wherein the second gaseous fuel stream is a compressed gaseous stream having a pressure between 50 MPa and 90 MPa and a temperature between -50° C. and 20° C.

6. The system of claim 1, wherein the first gaseous fuel stream and the second gaseous fuel stream have a pressure to meet a filling capability of 35 MPa and 70 MPa, respectively.

7. The system of claim 6, wherein the first maximum flow rate of the first pump is up to 280 Kg/hr and the second maximum flow rate of the second pump is less than 200 Kg/hr.

8. The system of claim 1, wherein at least one dispenser comprises at least two dispensers configured to refueling at least two vehicles simultaneously.

9. The system of claim 1, further comprising one or more additional pumps, wherein the system comprises three or more pumps in total with different combinations of pressure and flow capability.

10. The system of claim 1, wherein the system comprises multiple sets of a two-pump combination including the first pump, the second pump, the first heat exchanger, the second heat exchange, the first mixer and the second mixer.

11. The system of claim 1, further comprising an additional cryotank configured to hold at least one pump therein.

12. A hydrogen refueling station, comprising:
a cryotank configured to store a liquefied fuel therein, wherein the liquefied fuel is hydrogen;
a first pump having a first maximum flow rate and configured to compress and provide a first stream of the liquefied fuel having a first pressure from the cryotank;
a second pump having a second maximum flow rate and configured to compress and provide a second stream of the liquefied fuel having a second pressure from the cryotank, wherein the second maximum flow rate is lower than the first maximum flow rate, and the second pressure is higher than the first pressure;
a first heat exchanger fluidly connected with the first pump and configured to vaporize a first substream from the first stream of the liquefied fuel to provide the first vaporized substream;
a first mixer fluidly connected with the first pump and the first heat exchanger, and configured to combine the first vaporized substream and a second substream from the first stream of the liquefied fuel to provide a first gaseous fuel stream;
a second heat exchanger fluidly connected with the second pump and configured to vaporize a third substream from the second stream of the liquefied fuel to provide the second vaporized substream;
a second mixer fluidly connected with the second pump and the second heat exchanger, and configured to combine the second vaporized substream and a fourth substream from the second stream of the liquefied fuel to provide a second gaseous fuel stream;
a piping manifold fluidly connected with the first mixer and the second mixer; and
at least one dispenser fluidly connected with the piping manifold,
wherein the piping manifold is configured to deliver either or both of the first gaseous fuel stream and the second gaseous fuel stream to the at least one dispenser, and the at least one dispenser is configured to dispense either or both of the first gaseous fuel stream and the second gaseous fuel stream into an on-board storage tank in a vehicle.

13. The hydrogen refueling station of claim 12, wherein the first gaseous fuel stream and the second gaseous fuel stream have a pressure to meet a filling capability of 35 MPa and 70 MPa, respectively.

14. The hydrogen refueling station of claim 12, wherein at least one dispenser comprises at least two dispensers configured to refueling at least two vehicles simultaneously.

15. The hydrogen refueling station of claim 12, further comprising a controller configured to adjust a ratio of the first gaseous fuel stream and the second gaseous fuel stream to be dispensed to the at least one dispenser.

16. A method of using the system of claim 1, comprising:
providing a liquefied fuel stored inside a cryotank, wherein the liquefied fuel comprises hydrogen;
connecting one of the at least one dispenser to an on-board storage tank of a fuel cell vehicle;
initiating a refueling process by dispensing the first gaseous fuel stream into the on-board storage tank; and
completing the refueling process by dispensing at least one portion of the second gaseous fuel stream into the on-board storage tank.

17. The method of claim 16, further comprising dispensing a mixture of the first gaseous fuel stream and the second gaseous fuel stream into the on-board storage tank.

18. A method of using the system of claim 1, wherein the at least one dispenser comprises a first dispenser and a second dispenser, the method comprising:
providing a liquefied fuel stored inside a cryotank, wherein the liquefied fuel comprises hydrogen;
providing at least two vehicles in sequence, wherein an arrival time between the at least two vehicles is less than a time needed to refueling any of the at least two vehicles;
connecting a first dispenser to an on-board storage tank of a first vehicle;
refueling the first vehicle;
connecting a second dispenser to an on-board storage tank of a second vehicle; and
refueling the second vehicle.

19. The method of claim 16, wherein refueling the first vehicle comprises:
initiating refueling the first vehicle by dispensing the first gaseous fuel stream into the on-board storage tank of the first vehicle; and
completing refueling the first vehicle by dispensing at least one portion of the second gaseous fuel stream into the on-board storage tank of the first vehicle.

20. The method of claim 19, wherein refueling the second vehicle comprises:
initiating refueling the second vehicle by dispensing the second gaseous fuel stream into the on-board storage tank of the second vehicle when the first gaseous fuel stream is dispensed into the on-board storage tank of the first vehicle, or vice versa; and
completing refueling the second vehicle by dispensing at least one portion of the second gaseous fuel stream into the on-board storage tank of the second vehicle when refueling the first vehicle is completed.

21. The method of claim 16, wherein the first gaseous fuel stream and the second gaseous fuel stream have a pressure to meet a filling capability of 35 MPa and 70 MPa, respectively.
